(19) United States
(12) Patent Application Publication
(10) Pub. No.: US 2016/0224780 A1
(43) Pub. Date: Aug. 4, 2016

(54) DEVICE LOCKING PROCESS

(71) Applicant: Microsoft Technology Licensing, LLC, Redmond, WA (US)

(72) Inventors: Prajav Kukreja, Seattle, WA (US); Ibrahim Mohammad Ismail, Bellevue, WA (US); Octavian Tony Ureche, Bellevue, WA (US); Nathan Ide, Bothell, WA (US); Andrew V. Echols, Seattle, WA (US); Paresh Maisuria, Issaquah, WA (US); Neeraj Kumar Singh, Bellevue, WA (US); Yashar Bahman, Seattle, WA (US)

(21) Appl. No.: 14/614,367

(22) Filed: Feb. 4, 2015

(51) Int. Cl. G06F 21/44; G06F 21/62

(52) U.S. Cl. CPC G06F 21/44; G06F 21/6281; G06F 2221/032

(57) ABSTRACT

A facility for managing the state of an electronic device is described. A facility determines a maximum-inactivity-to-lock period length and a grace period length. The facility subtracts the grace period length from the maximum-inactivity-to-lock period length to obtain an inactivity-to-disable-display period length. During a time when the device is unlocked and a visual display of the device is enabled, the facility receives one or more first user input events. At a time that is the inactivity-to-disable-display period length after the latest first user input event is received, the facility disables the visual display to begin a grace period. At a time that is less than the grace period length later than the beginning of the grace period, the facility receives a second user input event. In response, the facility enables the visual display in order to provide authenticated access to the device without imposing any further authentication process.

### TECHNICAL FIELD

The described technology is directed to the field of security techniques for electronic devices.

### BACKGROUND

Many mobile devices, such as smartphones and tablet computers, have an integrated display used to present visual information to a user. In many cases, mobile devices also include a touchscreen digitizer that senses a user's physical contact with the display, allowing the user to interact with visual information presented by the display, such as by touching within a displayed button, flicking to scroll a displayed list, pinching to zoom out a displayed photo, etc.

Such mobile devices are commonly used for business activities, such as retrieving, reading, and responding to email messages received by the email account provided by the user's employer. To protect the confidentiality of these email messages, the user's employer typically imposes certain security policies on the mobile device as part of the process of enabling access to the email messages by the mobile device. Such policies can require behaviors by the mobile device, such as locking the mobile device if the mobile device hasn't received any user input for a specified period of time (called a “maximum inactivity period”), and requiring that the user reauthenticate in order to resume using the mobile device by inputting a password having at least a minimum number of characters.

In some conventional schemes according to which mobile devices operate, the mobile device both turns the display off and locks itself at the end of the maximum inactivity period. Any attempt to resume use of the mobile device after this point requires reauthentication.

### BRIEF DESCRIPTION OF THE DRAWINGS

FIG. 1 is a block diagram showing some of the components that may be incorporated in at least some of the computer systems and other devices on which the facility operates.

FIG. 2 is a form factor diagram showing an example of a device on which the facility operates.

FIG. 3 is a timeline diagram illustrating the multi-stage device locking process implemented by the facility.

FIG. 4 is a flow diagram showing steps typically performed by the facility in order to implement the multi-stage device locking process in some examples.

FIG. 5 is a data flow diagram showing transmission of such an enterprise security policy to the device.

FIG. 6 is a data structure diagram showing sample contents of a timing data structure maintained and used by the facility in some examples.

### DETAILED DESCRIPTION

The inventors have recognized significant disadvantages in the conventional approach of turning off a mobile device's display at the same time as locking the mobile device at the end of the maximum inactivity period. First, there are situations where it is frustrating to the user for the mobile device to lock without warning at the end of the maximum inactivity period, such as when the user is reading from the mobile device's display without touching the display or otherwise generating user input, or where the user has paused in using the mobile device to attend to a task not involving the mobile device, but intends to imminently return to using the mobile device.

Second, the inventors have recognized that a significant share of the electrical energy consumed by a mobile device goes to powering its display.

In response to their recognition of these and other disadvantages of the conventional approach, the inventors have conceived a multi-stage device locking process in which the display is turned off at a time before the end of the maximum inactivity period is reached. While the display is off and before the device is locked at the end of the maximum inactivity period—during a so-called “grace period—the user can touch the display or generate another form of user input to resume their use of the mobile device without having to reauthenticate, resetting the maximum inactivity period. The inventors have further conceived a software and/or hardware facility for implementing this multi-stage locking process (“the facility”).

In various examples, the facility is used in devices of a wide variety of additional types, including desktop and laptop computers, large screen touch devices, etc.

In some examples, the facility operates in connection with a maximum inactivity period specified locally by the user of this device. This can occur, for example, where no maximum inactivity period is specified by an administrative policy, or where a maximum inactivity period is specified by an administrative policy that is longer than the period specified locally by the user.

The facility provides the advantage that the maximum inactivity period policy is consistently and faithfully complied with.

The facility has the further advantage that a user who is still using the mobile device without providing input—or a user who has paused in using the mobile device but has it in their visual field—is warned by the display turning off that locking will soon occur, and can easily prevent it by touching the display.

The facility has the still further advantage of saving the electrical energy that would have been needed to power the display for the balance of the maximum inactivity period that corresponds to the grace period.

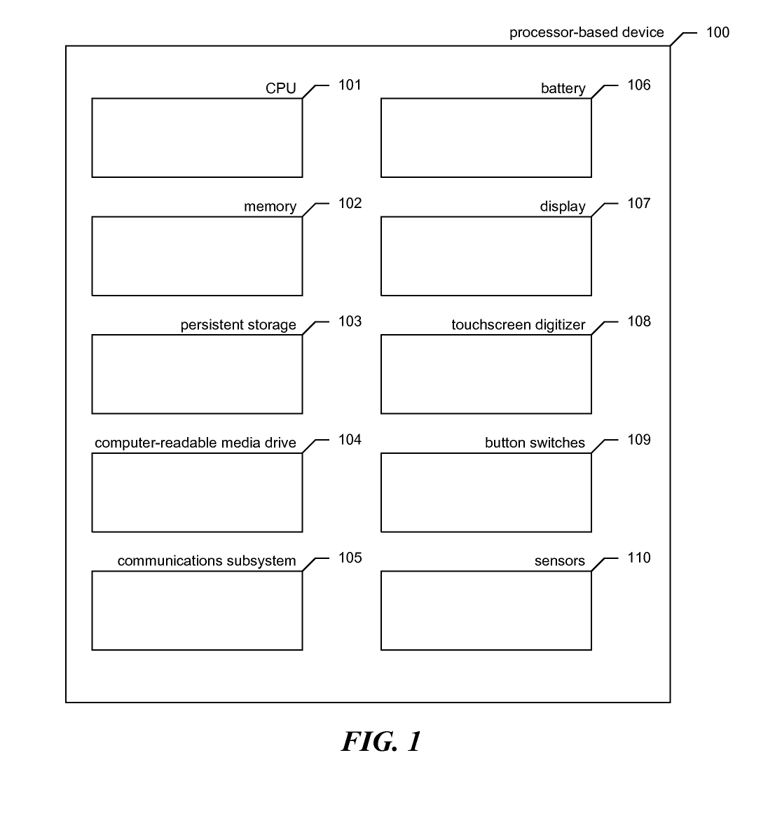

FIG. 1 is a block diagram showing some of the components that may be incorporated in at least some of the computer systems and other devices on which the facility operates. In various examples, these computer systems and other devices 100 can include server computer systems, desktop computer systems, laptop computer systems, tablet computer systems, netbooks, mobile phones, personal digital assistants, televisions, cameras, automobile computers, electronic media players, etc. In various examples, the computer systems and devices may include any number of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and/or a communications subsystem 105 for connecting the computer system to other computer systems and/or other devices to send and/or receive data, such as via the Internet or another wired or wireless network and its networking hardware, such as switches, routers, repeaters, electrical cables and optical fibers, light emitters and receivers, radio transmitters and receivers, and the like.

In various examples, these computer systems and other devices 100 may further include any number of the following: a battery 106 for storing electrical energy consumed by the device; a display 107 for presenting visual information, such as text, images, icons, documents, menus, etc.; a touchscreen digitizer 108 for sensing interactions with the display, such as touching the display with one or more fingers, styluses, or other objects; button switches 109, which the user can activate such as by pressing them, to provide certain forms of user input; and sensors 110, such as various kinds of position, orientation, acceleration, temperature, pressure, humidity, audio, image, and video sensors usable to obtain information about the device's condition and surroundings. In various examples, the computer systems and other devices 100 include input devices of various other types, such as keyboards, mice, styluses, etc. (not shown).

While computer systems configured as described above may be used to support the operation of the facility, those skilled in the art will appreciate that the facility may be implemented using devices of various types and configurations, and having various components.

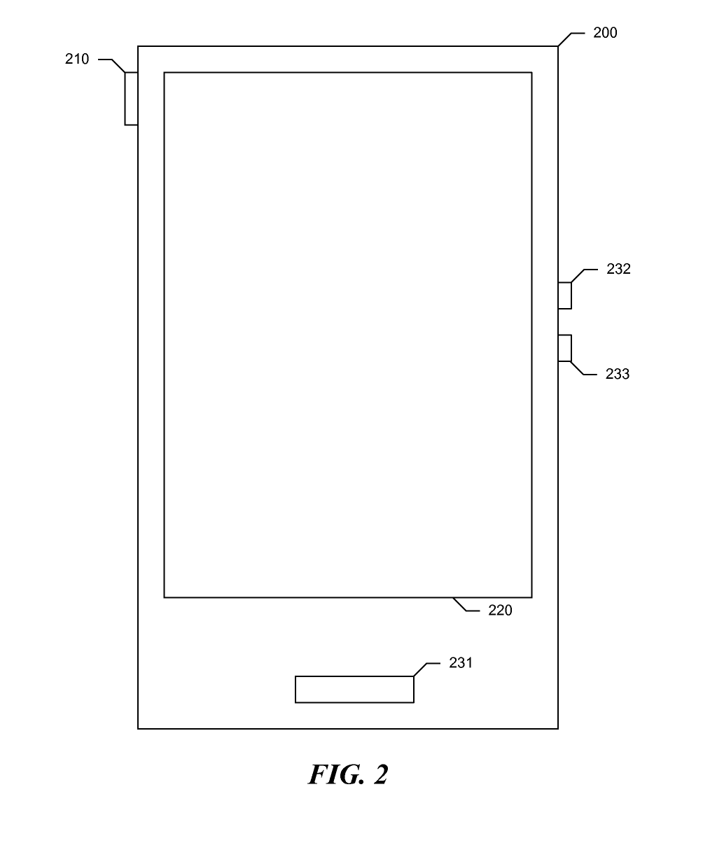

FIG. 2 is a form factor diagram showing an example of a device on which the facility operates. The device 200 includes a power button 210 that the user may activate in order to turn various aspects of the device on and off. The device further includes a display 220 that is outfitted with a touchscreen digitizer. As noted above, when the display is switched on, the device can present visual information on the display. Also, the user can touch the screen to generate user input, such as user input interacting with visual information presented on the display. While the touchscreen digitizer is in operation, it will sense and report such touches, including the position(s) on the display at which they occurred. The device also has a number of other buttons switches, such as a button 231 that can be activate by the user in order to return to a home or menu screen, and volume buttons 232 and 233 that can be activated by the user to increase or decrease the volume of audio generated by the device, such as via a speaker in the device (not shown) and/or via a headphone connector (not shown) to which headphones or other external speakers can be connected. Those skilled in the art will appreciate that the facility may be implemented using a wide variety of devices having various form factors.

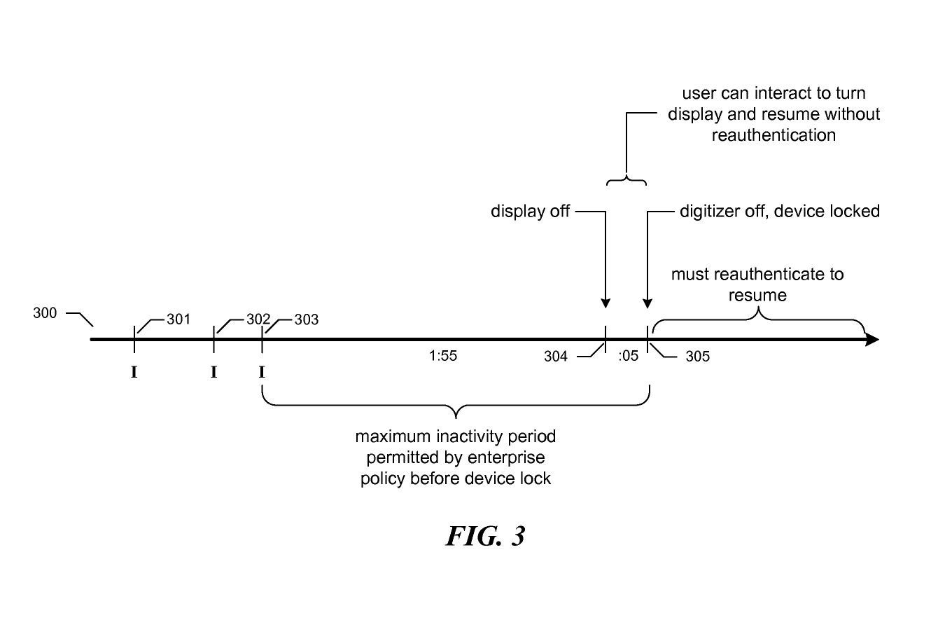

FIG. 3 is a timeline diagram illustrating the multi-stage device locking process implemented by the facility. The timeline shows times 301, 302, and 303 at which user interaction events are performed, such as touches on the screen registered by the digitizer. After the interaction that occurs at time 303, it can be seen that, if the user does not perform additional interactions, the maximum inactivity period permitted by the enterprise policy before the device will lock elapses at time 305, two minutes later. In order to provide a grace period five seconds long after the display has been turned off during which the user can interact to turn the display back on and resume use of the device without re-authentication, the facility turns the display off at time 304, which is five seconds before the grace period will expire at time 305, and 1 minute, 55 seconds after the last interaction at time 303. If the user performs an interaction between times 303 and 305, the facility turns the display back on, resets the maximum inactivity period, and allows the user to resume use of the device without reauthentication. If the user performs no interactions between times 303 and 305, then the digitizer is turned off, the device is locked, and the user must re-authenticate in order to resume using the device.

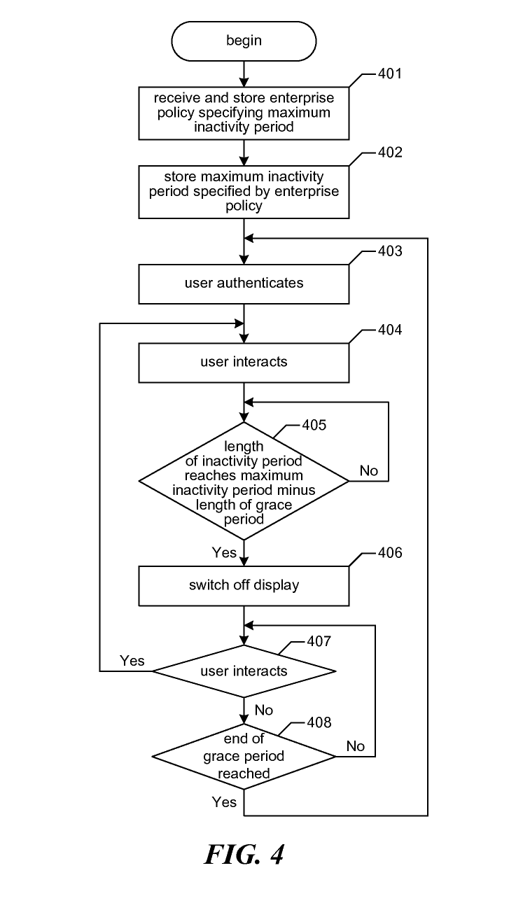

FIG. 4 is a flow diagram showing steps typically performed by the facility in order to implement the multi-stage device locking process in some examples. In step 401, the facility receives and stores an enterprise policy specifying a maximum inactivity period, after the expiration of which the device is to be locked.

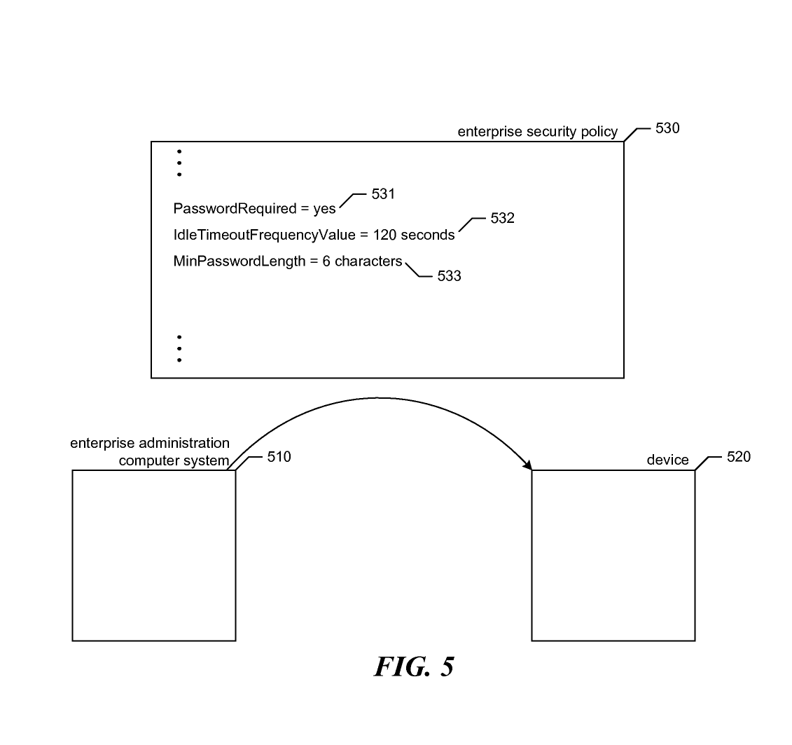

FIG. 5 is a data flow diagram showing transmission of such an enterprise security policy to the device. An enterprise administration computer system 510 sends to the device 520 an enterprise security policy 530. The enterprise security policy specifies a set of security requirements to be enforced by the device, including one specifying the length of maximum inactivity period. In the example, the enterprise security policy 530 includes a requirement 531 specifying that a password must be specified for the device by a user, and used to authenticate before using the device; a requirement 532 specifying a maximum inactivity period of 120 seconds—2 minutes; and a requirement 533 that the password specified by the user be at least six characters long.

Returning to FIG. 4, in step 402, the facility stores the maximum inactivity period specified by the enterprise policy received in step 401.

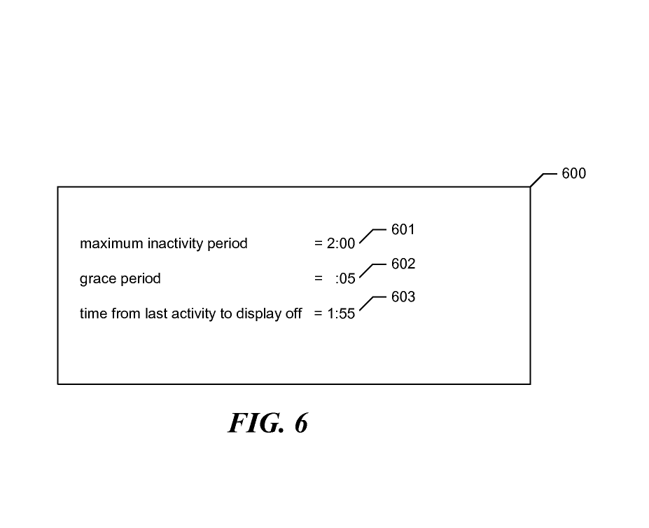

FIG. 6 is a data structure diagram showing sample contents of a timing data structure maintained and used by the facility in some examples. The data structure 600 includes the maximum inactivity period 601 specified by the security policy received in step 401—here, 2 minutes. The data structure further stores the length of the grace period during which the screen is off, the digitizer is on, and the user may perform an interaction to resume using the device without authentication. The data structure further stores an amount of time 603 which is the length of the period during which the display will be on after the last user interaction before the facility turns off the display and begins the grace period, here 1 minute and 55 seconds.

While FIG. 6 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; may contain a much larger number of rows than shown, etc.

Returning to FIG. 4, in step 403, the user authenticates to the device, such as by entering their password. In step 404, the user interacts with the device, such as by touching the screen, manipulating the buttons, providing audio input, etc. In step 405, if the length of an inactivity period since the time the user last interacted reaches a maximum inactivity period from the security policy minus the length of the grace period—here, 1 minute and 55 seconds, as shown in element 603 of FIG. 6—then the facility continues in step 406, else the facility continues in step 405. In step 406, the facility switches off the display, beginning the grace period. In step 407, if the user interacts with the device before the end of the grace period is reached, then the facility continues in step 405, ending the grace period, else the facility continues in step 408. In step 408, if the end of the grace period has been reached, then the facility continues in step 403, locking the device such that the user must reauthenticate before continuing to use it, else the facility continues in step 407 to continue the grace period.

Those skilled in the art will appreciate that the steps shown in FIG. 4 and in each of the flow diagrams discussed below may be altered in a variety of ways. For example, the order of the steps may be rearranged; some steps may be performed in parallel; shown steps may be omitted, or other steps may be included; a shown step may be divided into substeps, or multiple shown steps may be combined into a single step, etc.

In various examples, the set of interaction event types that the user can perform in order to reset the maximum inactivity time, thus delaying the beginning of the grace period, include one or more of screen touches; presses of the power button; presses of any button; voice or other audio input; gestures involving moving the device; interactions with a keyboard, mouse, stylus, etc.; and other forms of user input known to those of skill in the art.

In various examples, the set of interaction event types that the user can perform in order to turn the display on and resume use of the device during the grace period include one or more of screen touches; presses of the power button; presses of any button; voice or other audio input; gestures involving moving the device; interactions with a keyboard, mouse, stylus, etc.; and other forms of user input known to those of skill in the art.

In some examples, the facility maintains the applications active immediately before the grace period in a condition that permits them to resume execution quickly, such as maintaining privileges needed by the application to execute, maintaining in working memory portions of the application needed for it to execute, etc.

In some examples, while the facility turns the display off during the grace period, the application or applications that were being displayed immediately before the grace period retain the focus throughout the grace period, such that, as soon as the user exits the grace period by providing user input and the display is turned back on, the state of the display is the same as it was immediately before the grace period began, and the user can seamlessly resume interacting with the device. That is, no lock screen, or other display that differs from the display immediately before the beginning of the grace period, is displayed when the user exits the grace period, which would require the user to perform some navigation to resume the state of the device immediately before the grace period began. As part of this example, during the grace period, the facility absorbs user interaction events that have the effect of exiting the grace period, so that they are not received and acted upon by the application or applications that have retained the focus.

As one example, Exchange ActiveSync is a secure enterprise email exchange scheme that includes a mechanism for imposing security policies on devices. Exchange ActiveSync Policy Engine Overview, available at technet.microsoft.com/en-us/library/dn282287.aspx, which is hereby incorporated by reference in its entirety, describes the MaxinactivityTimeDeviceLock security requirement that may be used in connection with Exchange ActiveSync to establish a maximum inactivity period for the device.

In some examples, the facility operates in connection with mobile device management solutions, such as Microsoft Intune, whose operation is described by Configure Security Policy for Mobile Devices in Microsoft Intune, available at technet.microsoft.com/en-us/library/dn646984.aspx, and which is hereby incorporated by reference in its entirety, and which describes the use of a “Minutes of inactivity before screen turns off” security setting that may be used to specify a maximum inactivity time.

In some examples, one or more instances of computer-readable media collectively storing contents capable of causing a device to perform a method for managing its state are provided. The device has a visual display and being capable of detecting physical contacts with a substantially transparent cover of the visual display. The method comprises: receiving an enterprise security policy specifying a maximum inactivity to lock period length; accessing a grace period length; subtracting the grace period length from the maximum inactivity to lock period length to obtain an inactivity to disable display period length; during a time when the device is unlocked and the visual display is enabled, receiving one or more first user input events each corresponding to detected physical contacts with the visual display cover; at a time that is the disable display period length after the latest first user input event is received, disabling the visual display to begin a grace period during which the visual display is disabled and it is possible to generate input events; at a time that is less than the grace period length later than the beginning of the grace period, receiving a second user input event corresponding to a detected physical contact with the visual display cover; and, in response to receiving the second user input event at a time that is less than the grace period when later than the beginning of the grace period, enabling the visual display to provide authenticated access to the device without imposing any authentication process.

In some examples, a method for managing the state of an electronic device having a visual display is performed. The method comprises: determining a maximum inactivity to lock period length and a grace period length; subtracting the grace period length from the maximum inactivity to lock period length to obtain an inactivity to disable display period length; during a time when the device is unlocked and the visual display is enabled, receiving one or more first user input events; at a time that is the disable display period length after the latest first user input event is received, disabling the visual display to begin a grace period during which the visual display is disabled and it is possible to generate input events; at a time that is less than the grace period length later than the beginning of the grace period, receiving a second user input event; and, in response to receiving the second user input event at a time that is less than the grace period when later than the beginning of the grace period, enabling the visual display to provide authenticated access to the device without imposing any authentication process.

In some examples, a device is provided. The device comprises: a visual display; a digitizer adapted to register touch interactions with the visual display; a memory adapted to store a maximum inactivity to lock period length and a grace period length; and a processor adapted to: initialize the device to a first mode in which the visual display and digitizer are both enabled—while in the first mode, when a first period of time has elapsed since the latest touch interaction with the display registered by the digitizer, the first period of time being of a length corresponding to the difference between the maximum inactivity to lock period length stored by the memory and the grace period length stored by the memory, transitioning the device to a second mode in which the digitizer is enabled and the visual display is disabled—and, while in the second mode, when second period of time has elapsed since the latest touch interaction with the display registered by the digitizer, the second period of time being of a length corresponding to the maximum inactivity to lock period length stored by the memory, transitioning the device to a third mode in which the visual display and digitizer are both disabled.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1. One or more instances of computer-readable media collectively storing contents configured to cause a device to perform a method for managing its state, the device having a visual display and configured to detect physical contacts with a cover of the visual display, the method comprising:
receiving an enterprise security policy specifying a maximum-inactivity-to-lock period length;
accessing a grace period length;
subtracting the grace period length from the maximum-inactivity-to-lock period length to obtain an inactivity-to-disable-display period length;
during a time when the device is unlocked and the visual display is enabled, receiving one or more first user input events each corresponding to one or more detected physical contacts with the visual display cover;
at a time that is the inactivity-to-disable-display period length after the latest first user input event is received, disabling the visual display to begin a grace period during which the visual display is disabled, but still is configured to receive input events;
at a time that is less than or equal to the grace period length later than the beginning of the grace period, receiving a second user input event corresponding to a detected physical contact with the visual display cover; and
in response to receiving the second user input event at a time that is less than the grace period length later than the beginning of the grace period, enabling the visual display to provide authenticated access to the device without imposing any authentication process.

2. A method for managing a state of an electronic device having a visual display, comprising:
accessing an inactivity-to-disable-display period length, a grace period length, and a maximum-inactivity-to-lock period length that is the sum of the inactivity-to-disable-display period length and the grace period length;
during a time when the device is unlocked and the visual display is enabled, receiving one or more first user input events;
at a time that is the inactivity-to-disable-display period length after the latest first user input event is received, disabling the visual display to begin a grace period during which the visual display is disabled, but the electronic device still is configured to receive input events;
at a time that is less than the grace period length later than the beginning of the grace period, receiving a second user input event; and
in response to receiving the second user input event at a time that is less than the grace period length later than the beginning of the grace period, enabling the visual display to provide authenticated access to the device without imposing any authentication process.

3. The method of claim 2 wherein the maximum-inactivity-to-lock period length is determined based upon an amount of time specified by an enterprise security policy specified with respect to a class of devices all used by users associated with a selected organization.

4. The method of claim 2 wherein the maximum-inactivity-to-lock period length is determined based upon an amount of time specified by a security policy received wirelessly by the device.

5. The method of claim 2 wherein the maximum-inactivity-to-lock period length is determined based upon an amount of time specified by a security policy imposed by an organization as part of authorizing the device to access data in which the organization has a privacy interest.

6. The method of claim 2 wherein the second user input event is a display touch user input event.

7. The method of claim 2 wherein the second user input event is a physical button press input event.

8. The method of claim 2 wherein, during the time when the device is unlocked and the visual display is enabled, a selected program is executing that receives and acts on the received first user input events, the method further comprising preventing the selected program from receiving the second user input event, such that the selected program does not act on the second user input event.

9. The method of claim 8 wherein the preventing comprises designating a program other than the selected program to receive the second user input event.

10. The method of claim 8 wherein an operating system executes on the device, and wherein the preventing comprises designating a program other than the selected program that is a component of the operating system to receive the second user input event.

11. A device, comprising:
a visual display;
a digitizer configured to register touch interactions with the visual display;
a memory configured to store a maximum-inactivity-to-lock period length and a grace period length; and
a processor configured to:
initialize the device to a first mode in which the visual display and digitizer are both enabled;
while in the first mode, when a first period of time has elapsed since the latest touch interaction with the display registered by the digitizer, the first period of time being of a length corresponding to a difference between the maximum-inactivity-to-lock period length stored by the memory and the grace period length stored by the memory, transitioning the device to a second mode in which the digitizer is enabled and the visual display is disabled; and
while in the second mode, when a second period of time has elapsed since the latest touch interaction with the display registered by the digitizer, the second period of time being of a length corresponding to the maximum-inactivity-to-lock period length stored by the memory, transitioning the device to a third mode in which the visual display and digitizer are both disabled.

12. The device of claim 11 wherein, in the third mode, a user authentication action is required to return to the first mode.

13. The device of claim 11, the processor being further configured to:
while in the second mode, when the digitizer registers a touch interaction before expiration of the second period of time, transitioning the device to the first mode.

14. The device of claim 11, further comprising a power switch, the processor being further configured to:
while in the second mode, in response to the power switch being activated before expiration of the second period of time, transitioning the device to the first mode.

15. The device of claim 11, further comprising a radio configured to receive the maximum-inactivity-to-lock period length stored in the memory.

16. The device of claim 11, further comprising a communications subsystem for receiving the maximum-inactivity-to-lock period length stored in the memory from an organization in connection with the organization authorizing the device to access data owned by the organization.
